(19) United States
(12) Patent Application Publication
(10) Pub. No.: US 2007/0060388 A1
(43) Pub. Date: Mar. 15, 2007

(54) Electronic Game Character Exhibiting Traits Based on An Intelligence Algorithm

(75) Inventors: James R. Stelzer, Holland, PA (US); David S. Logan, Washington Crossing, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: MERIT INDUSTRIES, INC., Bensalem, PA (US)

(21) Appl. No.: 11/531,782

(22) Filed: Sep. 14, 2006

Related U.S. Application Data
(60) Provisional application No. 60/716,915, filed on Sep. 14, 2005.

(51) Int. Cl. A63F 13/00

(52) U.S. Cl. 463/43

(57) ABSTRACT

An amusement device has a display and an input device. The amusement device includes a memory that stores at least one electronic game and a system control program and a controller operatively coupled to the memory, the input device and the display. The electronic game has at least one virtual character, and the at least one virtual character has animated character traits. The controller controls the display based upon the system control program retrieved from the memory and based upon inputs from the input device. The controller is configured to (i) permit the user to selectively retrieve from the memory and play the at least one electronic game and (ii) modify the animated character traits being exhibited by the at least one virtual character as determined by an intelligence algorithm located in the control program based at least in part on the play of the game.

### CROSS REFERENCE TO RELATED APPLICATIONS

This application claims priority to U.S. Provisional Patent Application No. 60/716,915 filed on Sep. 14, 2005 entitled “Electronic Game Character Having Traits Based on Artificial Intelligence.”

### BACKGROUND OF THE INVENTION

An embodiment of the present invention relates generally to an amusement device having an electronic game and a method of playing an electronic game, and more particularly, to an amusement device having an electronic game with one or more virtual characters exhibiting traits determined by an intelligence algorithm based at least in part on play of the game.

Amusement devices having electronic games such as blackjack and poker variation card games for computers and touchscreens or other types of amusement devices are generally well known in the art. Amusement devices, such as game machines, which allow a user to select games from a video display are well known in the art such as those disclosed in U.S. Pat. Nos. 4,856,787 (“Itkis”); 5,575,717 (“Houriet, Jr., et al.”); 5,743,799 (“Houriet, Jr., et al.”), the entire contents of which are incorporated by reference herein, each of which shows a touchscreen for making a game selection from a menu of games. Such game machines or amusement devices typically operate upon input of currency (i.e., coin, token, paper money, credit/debit cards or the like) and are installed in locations such as bars, restaurants, airports, shopping malls, video arcades, casinos or the like. The game choices may include card games, sports games, games of skill, games of chance, action games, trivia games or the like.

Electronic games such solitaire, poker, blackjack, pool or the like for computers or touchscreens or other types of amusement devices are also generally well known in the art. One popular electronic game generally known as “Texas Hold'em,” is a poker variation card game. It is typically played with a standard 52 card deck and with two or more players and up to a maximum of 11 players. Regular poker hand type ranks apply to Texas Hold'em, for example, a flush beats a straight, a straight beats three of a kind and so on. Texas Hold'em includes five steps including “pre-flop,” “flop,” “turn,” “river,” and “showdown.” When the dealer button is pressed, each “player” is dealt one card. Then each player is dealt a second card. Both cards are face down. After everyone receives their “pocket/hold” or “hole” cards, i.e., the two cards face down just dealt, then the wagering begins. This phase is known as the pre-flop. The flop includes the dealer turning over three cards in the middle of the table referred to as the “flop.” The flop cards are community cards that each player can use to create a best possible hand in combination with their hole cards. After the flop, wagering occurs again. During the turn, the dealer turns over another card thereby providing four community cards. The fourth card is called the “turn” or sometimes loosely, the “fourth street.” Wagering occurs after the turn as well. When the dealer turns over the fifth and last community card, wagering occurs for the last time. The fifth community card is referred to as the “river” or loosely, “the fifth street.” The showdown includes the remaining players in the hand showing their cards in order starting from the person who wagered first. Each player uses his two cards and the five community cards to create the best possible hand of five total cards. A player can use any combination of the seven cards including just one of his hole cards and four community cards to create a hand of five cards. When the five community cards make the best possible hand, then all of the players remaining in the game split the pot which is referred to as the board plays. As in normal poker variation card games, players can fold or drop out at any time during a hand. Of course when a player folds, all of his or her wagers are lost at that point in time.

Computer and Internet versions of Texas Hold'em are generally well known. For example, one variation Texas Hold'em game can be played at http://www.partypoker.com. Partypoker.com is a registered trademark of WPC Productions Limited Corporation, Gibraltar. Partypoker.com provides an Internet server so that players can play at a virtual table against other real players. Each player logged into a game is assigned an avatar or an image of a person representing him or her. Partypoker can be played for free or for money against other players. Partypoker also provides for real money poker tournaments against a plurality of other players over a set period of time.

New variations of games which are more fast paced and require a player to strategize in order to win are currently sought after. However, some regulatory agencies (national, state or local) have “gaming” regulations which require that electronic games which award prizes be based on some element of skill. Since most card games such as poker and blackjack have an apparent “random deal,” they are generally categorized as games of chance. It is desirable to modify a game of chance so that it can be construed as a game of skill.

It is desirable to provide an amusement device having an electronic game and a method of playing the electronic game that is at least partially based upon player skill. Further, it is desirable to provide an amusement device having an electronic game of poker with a plurality of virtual characters having a plurality of displayed character traits determined by an intelligence algorithm and based at least in part on the play of the game.

### BRIEF SUMMARY OF THE INVENTION

Briefly stated, an embodiment of the present invention comprises an amusement device has a display and an input device. The amusement device includes a memory that stores at least one electronic game and a system control program and a controller operatively coupled to the memory, the input device and the display. The electronic game has at least one virtual character, and the at least one virtual character has animated character traits. The controller controls the display based upon the system control program retrieved from the memory and based upon inputs from the input device. The controller is configured to (i) permit the user to selectively retrieve from the memory and play the at least one electronic game and (ii) modify the animated character traits being exhibited by the at least one virtual character as determined by an intelligence algorithm located in the control program based at least in part on the play of the game.

Another embodiment of the present invention comprises an amusement device having a display and an input device. The amusement device includes a memory that stores at least one electronic game and a system control program and a controller operatively coupled to the memory, the input device and the display. The at least one electronic game has a plurality of virtual characters. Each of the virtual characters has animated character traits. The controller controls the display based upon the system control program retrieved from the memory and based upon inputs from the input device. The controller is configured to (i) permit the user to selectively retrieve from the memory and play the at least one electronic game and (ii) modify each of the respective animated character traits being exhibited by each of the plurality of virtual characters as determined by an intelligence algorithm located in the control program based at least in part on the play of the game.

Another embodiment of the present invention comprises an amusement device having a display, a processor, a memory and at least one control program for playing an electronic poker variation card game. The amusement device includes a playing area within the display for displaying a plurality of virtual characters, cards and a card shoe of an electronic deck of playing cards. Each card has a face side showing a suit and an associated value. The card shoe is configured to dispense cards from the electronic deck of cards to each of the virtual characters for play. The amusement device also includes a set of rules dictating the playing and scoring of the electronic poker variation card game, and a set of animated character traits associated with at least one of the virtual characters. The animated character traits are exhibited by the at least one virtual character as determined by an intelligence algorithm located in the control program based at least in part on the play of the game.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a screen shot of an electronic poker variation card game in accordance with preferred embodiments of the present invention;

FIG. 2 is a screen shot of the electronic variation poker game of FIG. 1 depicting one of a plurality of virtual characters raising a wager;

FIG. 3 is a screen shot of the electronic poker variation card game of FIG. 1 showing an animated character trait of one of the plurality of virtual characters;

FIG. 4 is a screen shot of the electronic poker variation card game of FIG. 1 showing an animated character trait of another one of the plurality of virtual characters;

FIG. 5 is a screen shot of the electronic variation poker game of FIG. 1 depicting another one of the plurality of virtual characters raising a wager;

FIG. 6 is a screen shot of the electronic poker variation card game of FIG. 1 showing a character trait of another one of the plurality of virtual characters; and

FIG. 7 is a perspective view of an electronic amusement device which can run the electronic poker variation card game in accordance with the present invention.

### DETAILED DESCRIPTION OF THE INVENTION

Certain terminology is used in the following description for convenience only and is not limiting. The words “a” and “an,” as used in the claims and in the corresponding portions of the specification, mean “one” or “at least one.”

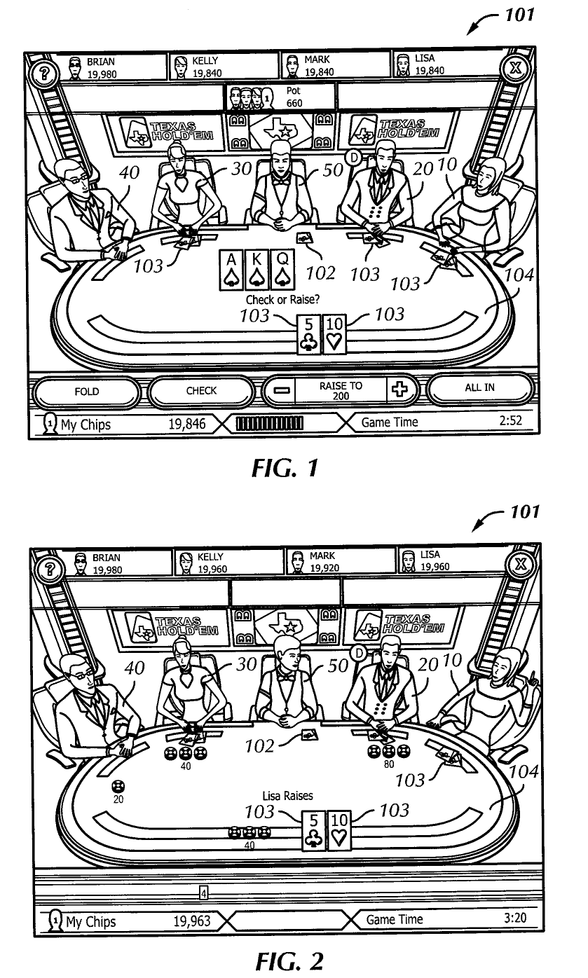

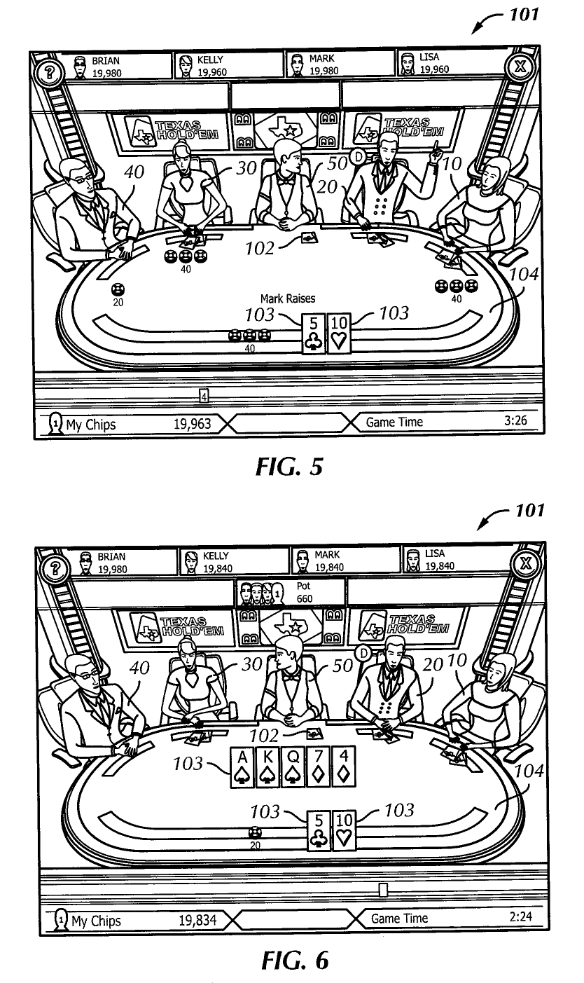

Referring to the drawings in detail, FIGS. 1-6 show an electronic game 101 in accordance with preferred embodiments of the present invention. While the electronic game 101 is depicted as a poker variation card game 101, the electronic game may be other games without departing from the present invention.

FIG. 7 depicts an amusement device 8 that runs the electronic game 101. The amusement device 8 includes a controller U1 and a memory U2. The amusement device 8 further includes a video display 9 which is operatively connected to the amusement device 8 controller U1. Preferably, the video display 9 is a touchscreen video display configured to accept touch input, which will be referred to hereinafter as touchscreen 9. As shown, the amusement device 8 is a table-top or counter-top apparatus. However, the amusement device 8 may be arranged in any configuration including table mount, wall mount, pole mount and the like without departing from the invention.

The amusement device 8 is a stand-alone computer system controlled by the controller or microprocessor U1, the memory U2 and a touchscreen video display driver (not labeled). For purposes of simplicity, the invention will be described with respect to the amusement device 8 throughout the remainder of the description, but it should be noted that embodiments of the present invention could be implemented with any variety of amusement devices 8 without departing from the spirit of the invention.

The memory U2 stores a plurality of electronic games 101 and a system control program. The controller U1 is operatively coupled to the memory U2, the input device 9 and the display 9 (i.e., the touchscreen display 9). The controller U1 controls the touchscreen display 9 based upon the system control program retrieved from the memory U2 and based upon inputs from the input device, in this case the touchscreen display 9. As used herein, the system control program refers to all of the software functions outside of the game or music files including an operating system, display control, input control, sound drivers and the like. Other input devices which may be connected to the amusement devices 8 include a pushbutton(s), a track-ball or touchpad, a mouse, a joy-stick, a foot-pedal, a voice recognition system, a keypad or keyboard or the like. But, preferably, the input device is the touchscreen display 9.

Alternatively, the memory U2 can be configured to run only a single game and the amusement device 8 is then a dedicated amusement device 8. Optionally, the amusement device 8 has a prize awarding system. For example, the amusement device 8 may be configured to only play a single type of card game like poker or blackjack without departing from the present invention.

The amusement device 8 may optionally include a communication interface to connect to other amusement devices 8 and/or to a remote server computer (not shown) in order to permit tournament play and/or remote accounting, remote prize awarding and the like.

The amusement device 8 includes an operating mode and a setup mode. When the operating mode is selected, a player or user is selectively permitted to play electronic games. When the setup mode is selected, the owner/operator is permitted to make system setup adjustments. To switch from the operating mode to the setup mode, a mode selector pushbutton (hardware not shown) is provided that is typically concealed from the users. The mode selector pushbutton may be implemented as a hidden software feature, but preferably the mode selector pushbutton is a simple pushbutton that is disposed inside a housing of the amusement device 8. The controller U1 controls the display 9 based upon the system control program retrieved from the memory U2 and based upon inputs from the input device 9. The controller U1 is configured to permit the user to selectively retrieve from the memory U2 and play the one of the plurality of electronic games 101.

One embodiment of the present invention is directed to the amusement device 8 which has the touchscreen display 9. The amusement device 8 includes the memory U2 that stores at least one electronic game 101 and a system control program and the controller U1 is operatively coupled to the memory U2 and the touchscreen display 9. The electronic game 101 has a virtual character 10, 20, 30, 40, 50, and the virtual character 10, 20, 30, 40, 50 has animated character traits. Preferably, the at least one electronic game 101 has a plurality of virtual characters 10, 20, 30, 40, 50 and each of the virtual characters 10, 20, 30, 40, 50 has animated character traits.

The controller U1 controls the touchscreen (display) 9 based upon the system control program retrieved from the memory U2 and based upon inputs from the touchscreen (input device) 9. The controller U1 is configured to (i) permit the user to selectively retrieve from the memory U2 and play the at least one electronic game 101 and (ii) modify the animated character traits being exhibited by the virtual character 10, 20, 30, 40, 50 as determined by an intelligence algorithm located in the control program based at least in partly on the play of the electronic game 101.

Preferably, the intelligence algorithm in the system control program is modifiable by a network connection (e.g., Internet), a removable memory device (e.g., FlashRAM) or a wireless connection (e.g., Bluetooth). The intelligence algorithm can be modified by a configuration file (e.g., Appendices 1-3), where the configuration file includes a plurality of data attributes used by the intelligence algorithm to determine the animated character traits. Appendices 1-3 show exemplary configuration files for an electronic poker variation card game 101, as described below.

The intelligence algorithm determines the animated character traits being exhibited by the virtual character 10, 20, 30, 40, 50 based at least in part on the play of the game 101. For example, in a card game the virtual character 10, 20, 30, 40, 50 may use a first tell when the respective virtual character 10, 20, 30, 40, 50 has a defined “strong hand” and may use a second tell when the respective virtual character 10, 20, 30, 40, 50 has a defined “weak hand.” A defined “strong hand” or a defined “weak hand” may be based on numerically rating the cards dealt to the respective virtual character 10, 20, 30, 40, 50. A defined “strong hand” or a defined “weak hand” may also be determined by the intelligence algorithm based on the configuration file or the like, for all virtual characters 10, 20, 30, 40, 50 or separately for each respective virtual character 10, 20, 30, 40, 50. The intelligence algorithm may vary how often the tells are used, how often they bet, how often they fold or the like, based on percentages, based on time, based on events or the like. For example, in an action game, like Pac-man, the “ghosts” may be the virtual characters 10, 20, 30, 40, 50, and the virtual characters 10, 20, 30, 40, 50 may respond to the number of dots remaining on the screen, moves by the user, bonuses or the like. The intelligence algorithm can be modified from time to time, e.g., by downloading a different configuration file (see e.g., Appendices 1-3), so that the electronic game 101 does not become too predictable or too easy to play.

Referring again to FIGS. 1-6, the electronic game 101 is the electronic poker variation card game 101 that includes a playing area 104 and a conventional deck 102 of playing cards 103. Each conventional deck 102 of playing cards 103 has a plurality of individual playing cards 103. The deck 102 of cards 103 is a conventional deck of cards 103 comprising 52 cards, but may be other decks 102 of cards 103 depending on the electronic game 101, e.g., blackjack or other multi-deck games. Each of the individual playing cards 103 has an associated face suit such as spade, club, heart or diamond, displayed on a face up side of each of the individual playing cards 103. The cards 103 also have an associated face value (i.e., ace, two, three, four, five, six, seven, eight, nine, ten, jack, queen and king). The electronic card game 101 includes a playing area 104 within a display and a plurality of virtual characters 10, 20, 30, 40, 50. The game 101 is configured to dispense cards 103 from the electronic deck 102 of cards 103 for play. The electronic card game 101 has a set of rules dictating scoring of the electronic poker variation card game 101.

The set of rules for the card game 101 including (i) each player placing a wager before any cards 103 are dealt; (ii) dealing two cards 103 to each player (virtual character) 10, 20, 30, 40 face down; (iii) providing each player (virtual character) 10, 20, 30, 40 the opportunity to add to their wager by a first amount after they view their first two cards 103 before any hole cards 103 are dealt; (iv) displaying first, second and third hole cards 103 and providing each player (virtual character) 10, 20, 30, 40 an opportunity to increase their wager by a second amount; (v) displaying a fourth hole card 103 and providing each player (virtual character) 10, 20, 30, 40, an opportunity to add to their wager by a third amount; (vi) displaying a fifth hole card 103; and (vii) paying each player (virtual character) 10, 20, 30, 40 having a winning hand for their total respective wager including their respective original wager and the first, second and third amounts, if applicable, based upon a predetermined payout table. Each of the virtual characters 10, 20, 30, 40 has animated character traits. The animated character traits are determined by the intelligence algorithm in a control program of the amusement device 8. The dealer 50 may also optionally have animated character traits depending on the electronic card game 101 being played.

The poker variation card game 101 includes a personality module or character trait module which can be stored, downloaded or updated. The character trait module may simply be a computer file, such as one of the configuration files shown in Appendices 1-3, that includes data about how virtual characters 10, 20, 30, 40, 50 will “act” during a round of play. The character trait module may be downloaded via network connection such as the Internet in order to allow an amusement device 8 to have the intelligence algorithm of the electronic game 101 adjusted as desired. The electronic variation card game 101 permits each of the virtual characters 10, 20, 30, 40, 50 to have their own “personality.” The personality is basically the virtual animated character traits of the virtual characters 10, 20, 30, 40, 50 such as visual indicators of what they are physically doing. The visual indicators of their character traits may include aggressiveness, adjusting their glasses, scratching their hand, looking to the right, looking to the left, looking down or the like. Such character traits in poker terms are typically known as “tells.” By learning the tells of a particular player (virtual character) 10, 20, 30, 40, 50, one can determine how to wager against the player (virtual character) 10, 20, 30, 40, 50. It is desirable that the character traits of the players (virtual characters) 10, 20, 30, 40, 50 be adjustable to make tournaments more competitive and/or tp change a game of chance to an at least partially game of skill. Table 1 shows an exemplary rule based setting of the intelligence algorithm and Table 2 shows sample configurations for the virtual characters 10, 20, 30, 40. In this example, virtual character 50 is the dealer and has no adjustable personality/character traits.

TABLE 1

| | |
|---|---|
| 1. | Each virtual character 10, 20, 30, 40 has two playing attributes. |

The first attribute is how often he or she will play a hand (call or fold).
The second attribute is how aggressive he or she is when betting.

| | |
|---|---|
| 2. | How often each virtual character 10, 20, 30, 40 plays and how each |

virtual character 10, 20, 30, 40 bets are rated on a scale of 0-2.

| | |
|---|---|
| Play Rating: | 0 Plays conservative, unless holding a good hand. |
| Play Rating: | 1 Plays an average number of hands. |
| Play Rating: | 2 Plays both good and bad hands. |
| Bet Rating: | 0 Does not raise very often. |
| Bet Rating: | 1 Raises on an average number of hands. |
| Bet Rating: | 2 Aggressive raiser. |

| | |
|---|---|
| 3. | Each virtual character 10, 20, 30, 40 has 2 tells when they bet |
| | or raise. |

The first tell is a bluffing tell. The second tell is a strong hand tell.

Brian touches his glasses or checks his cards
Kelly scratches her wrist or checks her cards
Mark taps his fingers or checks his cards
Lisa knocks on the table or checks her cards

TABLE 2
Brian (virtual character 40)

| | | |
|---|---|---|
| Play Rating: | 0 | Plays conservative, unless holding a good hand. |
| Bet Rating: | 2 | Aggressive raiser. |
| Bluffing | 70% | |
| Tell % | 88% | |

primary/secondary trait = He checks his cards/He touches his glasses [0/1]
Kelly (virtual character 30)

| | | |
|---|---|---|
| Play Rating: | 1 | Plays an average number of hands. |
| Bet Rating: | 1 | Raises on an average number of hands. |
| Bluffing | 90% | |
| Tell % | 68% | |

primary/secondary trait = She scratches her wrist/She checks her
cards [0/1]
Mark (virtual character 20)

| | | |
|---|---|---|
| Play Rating: | 2 | Plays both good and bad hands. |
| Bet Rating: | 2 | Aggressive raiser. |
| Bluffing | 90% | |
| Tell % | 68% | |

primary/secondary trait = He checks his cards/He taps his fingers [0/1]
Lisa (virtual character 10)

| | | |
|---|---|---|
| Play Rating: | 2 | Plays both good and bad hands. |
| Bet Rating: | 0 | Does not raise very often. |
| Bluffing | 70% | |
| Tell % | 78% | |

primary/secondary trait = She knocks on the table/She checks her cards.
When each virtual character 10, 20, 30, 40, 50 has a good hand or
is bluffing, the respective virtual character 10, 20, 30, 40, 50
do their tell 70% of the time.

Preferably, each of the virtual characters 10, 20, 30, 40, 50 have unique character traits based on the same personality module (configuration file). It is contemplated that all the virtual characters 10, 20, 30, 40, 50 have the same character traits based on the same personality module (configuration file). Alternately, each character 10, 20, 30, 40, 50 can have a different set of character traits based upon a different personality module (configuration file). Appendices 1-3 show exemplary configuration files for the electronic poker variation card game 101. However, there may also be separate configuration files for each of the virtual characters 10, 20, 30, 40, 50.

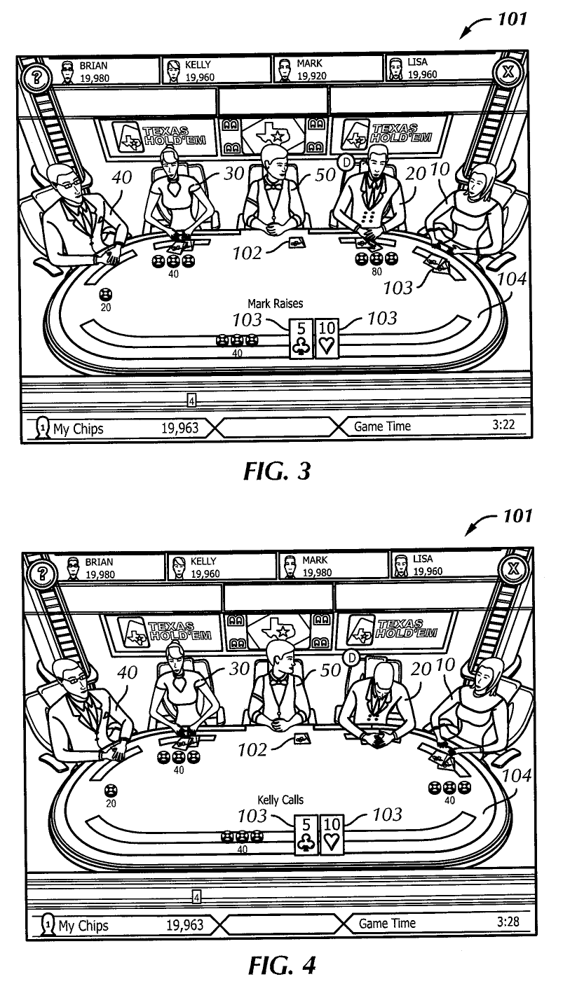

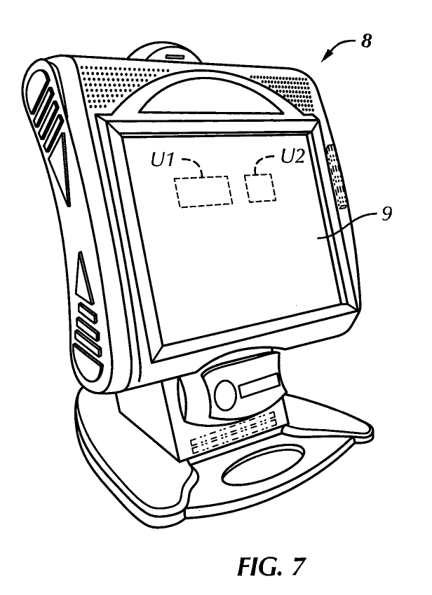

FIG. 3 shows an animated character trait of player (virtual character) 10. In FIG. 3, virtual character 10 looks down at her cards when “Mark Raises” (virtual character 20). FIG. 4 shows an animated character trait of player (virtual character) 10. In FIG. 4, virtual character 10 bows his head when “Kelly Calls” (virtual character 30). FIG. 6 shows a character trait of player 30. In FIG. 6, virtual character 30 scratches her right hand after “Mark Raises” (virtual character 20) and the wagering is to virtual character 30. In the electronic game 101, one of the players is the user of the amusement device 8, which may have a virtual character 10, 20, 30, 40, 50 or not, but the intelligence algorithm is for controlling the character traits of the virtual characters 10, 20, 30, 40, 50 controlled by the controller U1.

The poker variation card game is shown as “Texas Hold'em.” However, embodiments of the present invention can be applied equally in other electronic games where a player plays against other players or virtual characters 10, 20, 30, 40, 50. For example, in other poker games and variation poker games or any other competitive game requiring reading and/or strategically playing or bluffing other players such as virtual characters 10, 20, 30, 40, 50. The electronic game 101 can be a card game, a strategy game, an action game, a sports game or a linkable multi-player game. The electronic game 101 can be Texas Hold'em, poker, blackjack, hearts, spades, euchre, pinochle, Uno, Pac-man, soccer, basketball, football, baseball, hockey, air-hockey, golf or the like.

Embodiments of the present invention may be implemented with any combination of hardware and software. If implemented as a computer implemented apparatus, the present invention is implemented using means for performing all the steps and functions described above.

Embodiments of the present invention can be included in an article of manufacture (e.g., one or more computer program products) having, for instance, computer useable media. The media has embodied therein, for instance, computer readable program code, means for providing and facilitating the mechanisms of the present invention. The article of manufacture can be included as part of a computer system or sold separately.

A character may be a virtual animated person, animated animal, animated creature, animated fish, animated object or the like. Character should not be construed as being limited to virtual animated people or animals, but may also include animated objects, animated indicia or the like.

From the foregoing, it can be seen that the present invention comprises an amusement device having an electronic game with one or more virtual characters exhibiting traits determined by an intelligence algorithm based at least in part on play of the game. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

```
APPENDIX 1
- <AITexasHoldEm>
- <Player>
  <PLAYERID>10</PLAYERID>
  <PLAYING_RATING>2</PLAYING_RATING>
  <BETTING_RATING>1</BETTING_RATING>
  <BLUFF_PERCENT>70</BLUFF_PERCENT>
  <TELL_PERCENT>78</TELL_PERCENT>
  <BLUFF_TELL_SWITCH>1</BLUFF_TELL_SWITCH>
  </Player>
- <Player>
  <PLAYERID>20</PLAYERID>
  <PLAYING_RATING>1</PLAYING_RATING>
  <BETTING_RATING>0</BETTING_RATING>
  <BLUFF_PERCENT>90</BLUFF_PERCENT>
  <TELL_PERCENT>68</TELL_PERCENT>
    <BLUFF_TELL_SWITCH>0</BLUFF_TELL_SWITCH>
  </Player>
- <!-- Just in case need one for spot 3, if jp ordered them differently
  -->
- <Player>
  <PLAYERID>30</PLAYERID>
  <PLAYING_RATING>1</PLAYING_RATING>
  <BETTING_RATING>0</BETTING_RATING>
  <BLUFF_PERCENT>90</BLUFF_PERCENT>
  <TELL_PERCENT>68</TELL_PERCENT>
  <BLUFF_TELL_SWITCH>0</BLUFF_TELL_SWITCH>
  </Player>
- <Player>
  <PLAYERID>40</PLAYERID>
  <PLAYING_RATING>2</PLAYING_RATING>
  <BETTING_RATING>2</BETTING_RATING>
  <BLUFF_PERCENT>70</BLUFF_PERCENT>
  <TELL_PERCENT>88</TELL_PERCENT>
  <BLUFF_TELL_SWITCH>1</BLUFF_TELL_SWITCH>
  </Player>
-->
</AITexasHoldEm>
```

```
APPENDIX 2
- <AITexasHoldEm>
- <!-- had the header AIDefs but it comlained about it
  -->
- <Player>
  <PLAYERID>10</PLAYERID>
  <PLAYING_RATING>0</PLAYING_RATING>
  <BETTING_RATING>0</BETTING_RATING>
    <BLUFF_PERCENT>82</BLUFF_PERCENT>
  <TELL_PERCENT>72</TELL_PERCENT>
  <BLUFF_TELL_SWITCH>0</BLUFF_TELL_SWITCH>
  </Player>
- <Player>
  <PLAYERID>20</PLAYERID>
  <PLAYING_RATING>2</PLAYING_RATING>
  <BETTING_RATING>2</BETTING_RATING>
  <BLUFF_PERCENT>92</BLUFF_PERCENT>
  <TELL_PERCENT>62</TELL_PERCENT>
  <BLUFF_TELL_SWITCH>0</BLUFF_TELL_SWITCH>
  </Player>
  <PLAYERID>30</PLAYERID>
  <PLAYING_RATING>1</PLAYING_RATING>
  <BETTING_RATING>1</BETTING_RATING>
  <BLUFF_PERCENT>92</BLUFF_PERCENT>
  <TELL_PERCENT>62</TELL_PERCENT>
  <BLUFF_TELL_SWITCH>0</BLUFF_TELL_SWITCH>
  </Player>
- <Player>
  <PLAYERID>40</PLAYERID>
  <PLAYING_RATING>2</PLAYING_RATING>
  <BETTING_RATING>1</BETTING_RATING>
  <BLUFF_PERCENT>76</BLUFF_PERCENT>
  <TELL_PERCENT>69</TELL_PERCENT>
  <BLUFF_TELL_SWITCH>1</BLUFF_TELL_SWITCH>
  </Player>
  </AITexasHoldEm>
```

```
APPENDIX 3
- <AITexasHoldEm>
  -->
- <Player>
  <PLAYERID>10</PLAYERID>
  <PLAYING_RATING>2</PLAYING_RATING>
  <BETTING_RATING>0</BETTING_RATING>
  <BLUFF_PERCENT>72</BLUFF_PERCENT>
  <TELL_PERCENT>87</TELL_PERCENT>
  <BLUFF_TELL_SWITCH>0</BLUFF_TELL_SWITCH>
  </Player>
- <Player>
  <PLAYERID>20</PLAYERID>
  <PLAYING_RATING>1</PLAYING_RATING>
  <BETTING_RATING>1</BETTING_RATING>
  <BLUFF_PERCENT>76</BLUFF_PERCENT>
  <TELL_PERCENT>95</TELL_PERCENT>
  <BLUFF_TELL_SWITCH>1</BLUFF_TELL_SWITCH>
  </Player>
- <Player>
  <PLAYERID>30</PLAYERID>
  <PLAYING_RATING>0</PLAYING_RATING>
  <BETTING_RATING>0</BETTING_RATING>
  <BLUFF_PERCENT>92</BLUFF_PERCENT>
  <TELL_PERCENT>83</TELL_PERCENT>
  <BLUFF_TELL_SWITCH>1</BLUFF_TELL_SWITCH>
  </Player>
- <Player>
  <PLAYERID>40</PLAYERID>
  <PLAYING_RATING>1</PLAYING_RATING>
  <BETTING_RATING>2</BETTING_RATING>
  <BLUFF_PERCENT>92</BLUFF_PERCENT>
  <TELL_PERCENT>91</TELL_PERCENT>
  <BLUFF_TELL_SWITCH>0</BLUFF_TELL_SWITCH>
  </Player>
  </AITexasHoldEm>
```

We claim:

1. An amusement device having a display and an input device, the amusement device comprising:
a memory that stores at least one electronic game and a system control program, the at least one electronic game having at least one virtual character, the at least one virtual character having animated character traits; and
a controller operatively coupled to the memory, the input device and the display, the controller controlling the display based upon the system control program retrieved from the memory and based upon inputs from the input device,
the controller being configured to:
(i) permit a user to selectively retrieve from the memory and play the at least one electronic game; and
(ii) modify the animated character traits being exhibited by the at least one virtual character as determined by an intelligence algorithm located in the control program based at least in part on the play of the game.

2. The amusement device of claim 1, wherein the intelligence algorithm in the system control program is modifiable by one of a network connection, a removable memory device and a wireless connection.

3. The amusement device of claim 2, wherein the intelligence algorithm is modified by a configuration file, the configuration file includes a plurality of data attributes used by the intelligence algorithm to determine the animated character traits.

4. The amusement device of claim 1, wherein the at least one electronic game is at least partially based on player skill in learning the animated character traits.

5. The amusement device of claim 1, wherein the at least one electronic game is one of a card game, a strategy game, an action game, a sports game and a linkable multi-player game.

6. The amusement device of claim 1, wherein the at least one electronic game is one of Texas Hold'em, poker, blackjack, hearts, spades, euchre, pinochle, Uno, Pac-man, soccer, basketball, football, baseball, hockey, air-hockey and golf.

7. The amusement device of claim 1, wherein the memory stores a plurality of electronic games.

8. The amusement device of claim 1, wherein the input device is one of a pushbutton, a touchscreen, a touchpad, a trackball, a mouse, a joystick, a foot-pedal, a voice-recognition system, a keypad and a keyboard.

9. An amusement device having a display and an input device, the amusement device comprising:
a memory that stores at least one electronic game and a system control program, the at least one electronic game having a plurality of virtual characters, each of the virtual characters having animated character traits; and
a controller operatively coupled to the memory, the input device and the display, the controller controlling the display based upon the system control program retrieved from the memory and based upon inputs from the input device,
the controller being configured to:
(i) permit a user to selectively retrieve from the memory and play the at least one electronic game; and
(ii) modify each of the respective animated character traits being exhibited by each of the plurality of virtual characters as determined by an intelligence algorithm located in the control program based at least in part on the play of the game.

10. The amusement device of claim 9, wherein the intelligence algorithm in the system control program is modifiable by one of a network connection, a removable memory device and a wireless connection.

11. The amusement device of claim 10, wherein the intelligence algorithm is modified by a configuration file, the configuration file includes a plurality of data attributes used by the intelligence algorithm to determine the animated character traits.

12. The amusement device of claim 9, wherein the at least one electronic game is at least partially based on player skill in learning the animated character traits.

13. The amusement device of claim 9, wherein the at least one electronic game is one of a card game, a strategy game, an action game, a sports game and a linkable multi-player game.

14. The amusement device of claim 9, wherein the at least one electronic game is one of Texas Hold'em, poker, blackjack, hearts, spades, euchre, pinochle, Uno, Pac-man, soccer, basketball, football, baseball, hockey, air-hockey and golf.

15. The amusement device of claim 9, wherein the memory stores a plurality of electronic games.

16. The amusement device of claim 9, wherein the input device is one of a pushbutton, a touchscreen, a touchpad, a trackball, a mouse, a joystick, a foot-pedal, a voice-recognition system, a keypad and a keyboard.

17. An amusement device including a display, a processor, a memory and at least one control program for playing an electronic poker variation card game comprising:
a playing area within the display for displaying a plurality of virtual characters, cards and a card shoe of an electronic deck of playing cards, each card having a face side showing a suit and an associated value, the card shoe being configured to dispense cards from the electronic deck of cards to each of the virtual characters for play;
a set of rules dictating the playing and scoring of the electronic poker variation card game; and
a set of animated character traits associated with at least one of the virtual characters, the animated character traits being exhibited by the at least one virtual character as determined by an intelligence algorithm located in the control program based at least in part on the play of the game.
